(19) United States
(12) Patent Application Publication
(10) Pub. No.: US 2006/0160569 A1
(43) Pub. Date: Jul. 20, 2006

(54) Cellular phone and portable storage device using the same

(75) Inventors: Chia-Jung Chen, Tainan City (TW); Shih-Chang Hu, Hsin-Chu City (TW); Ping-Chun Lin, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/240,251

(22) Filed: Sep. 30, 2005

Related U.S. Application Data
(60) Provisional application No. 60/643,890, filed on Jan. 14, 2005.

(51) Int. Cl. H04B 1/38

(52) U.S. Cl. 455/557

(57) ABSTRACT

A cellular phone is provided. A connector is used for connecting cellular phone physically to a connection port of a computer. A nonvolatile storage device stores data received from the computer. A controller determines whether the cellular phone operates in a storage mode or a phone mode. When the cellular phone operates in the storage mode, it receives data from the computer via the connector, and stores the received data in the storage device. When the cellular phone operates in the phone mode, it executes a default functionality of the cellular phone.

### BACKGROUND

The invention relates to a cellular phone and in particular to a cellular phone that can retrieve, store, and process data originally stored in a computer system, and be utilized as an external storage device for the computer system.

Cellular phones are widely used, and their functionality has increased dramatically in recent years. Advances in semiconductor technology have enabled cellular phones to perform a wide variety of tasks, facilitating daily activities. Cellular phones, for example, can be used to place calls, take photographs, access the Internet, send and receive email, check stock quotes and sports scores, and operate as a personal digital assistant (or PDA) and MP3 player.

Data required for performing the described tasks is difficult to input manually via a keyboard, and is generally downloaded through a telephone network or via a wireless connection. Downloading through a telephone network is time consuming and requires a connection fee. A typical wireless connection, however, does not provide enough bandwidth to effectively download a large amount of data, such as a large image or video file.

Additionally, as cellular phone functionality increases, memory capacity therein increases accordingly, as does the amount of data required for performing the described tasks.

According to a conventional method, a memory of a cellular phone can be used as an external storage medium for a computer. For a computer, in order to communicate with a cellular phone and utilize a memory therein as external storage medium, vendor-provided software must be pre-installed in the computer.

FIG. 1 is a schematic view of a conventional computer utilizing a cellular phone as an external storage device. A cellular phone 150 is connected to a computer 100 via a USB cable 13. Both computer 100 and cellular phone 150 comprise hardware and software components, wherein the computer 100 comprises a hardware component 120 and a software component 110, and the cellular phone 150 comprises a hardware component 170 and a software component 160. The software component 110 comprises an application program 111, a vendor specific driver 113, and a USB host controller/driver 115. Typically, the application program 111 and vendor specific driver 113 are provided by a cellular phone manufacturer, and installed in the computer 100 by a user. In order to communicate with an external device via the USB cable 13, the hardware component 120 comprises a USB hardware 121 and a USB interface 123. In order to receive and transmit data via the USB cable 13, the hardware component 170 comprises USB device 171 and a USB interface 173, and the software component 160 comprises a USB driver 165 and a USB command parsing engine 164. The USB command parsing engine 164 parses a command submitted via the vendor-provided application program 111, and data stored in a memory 175 is retrieved and/or stored accordingly. Utilization of the data stored in the memory 175 is accomplished through a file system 167 and a memory driver 169. For example, the memory 175 of the cellular phone 150 is a non-volatile memory, and the memory driver 169 is a Flash driver.

In order to use the memory 175 of the cellular phone 150 as an external storage of the computer 100, application program 111 and vendor specific driver 113 must be installed. A command is submitted via the application program 111 and the vendor specific driver 113 to transmit and store data from the memory 175 of the cellular phone 150. The command is transferred to the cellular phone 150 via the USB driver 115, USB hardware 121, USB interface 123, and the USB cable 13. The command is then received by the USB interface 173, and transferred to the USB command parsing engine 164 via the USB device 171 and USB driver 165. The command is parsed by the USB command parsing engine 164 and transmitted to the file system 167. The file system 167 retrieves data from and/or stores data in the memory 175 according to the parsed command. The file system 167 used for managing data transfer between the computer 100 and cellular phone 150 can used for data management while an incoming call is received by the cellular phone 150.

In the conventional method, the installation of the application program 111 and the vendor specific driver 113 is required, and thus inconvenience and limitation are incurred.

### SUMMARY

The present invention provides a cellular phone. The cellular phone comprises a connector, a nonvolatile storage device, and a controller. The connector is used for physically connecting the cellular phone to a connection port of a computer. The nonvolatile storage device stores data received from the computer. The controller determines whether the cellular phone operates in a storage mode or a phone mode. When the cellular phone operates in the storage mode, it receives data from the computer via the connector, and stores the received data in the storage device. When the cellular phone operates in the phone mode, it executes a default functionality of the cellular phone.

Also provided is a cellular phone connected to a connection port of a computer based on connection standard, wherein the computer comprises a computer file system. The cellular phone comprises a connector, a nonvolatile storage device, a phone file system, and a controller. The connector is used for physically connecting the cellular phone to the connection port of the computer. The nonvolatile storage device stores data. The phone file system manipulates the data stored in the nonvolatile storage device. The controller determines whether the cellular phone is operating in a storage mode or a phone mode. When the cellular phone operates in the storage mode, it receives data from the computer via the connector, and stores the received data in the nonvolatile storage device under the directions of the computer file system. When the cellular phone operates in the phone mode, it executes a default functionality of the cellular phone, wherein the default functionality utilizes the data stored in the nonvolatile storage device via the phone file system.

Also provided is a cellular phone. The cellular phone comprises a connector, a storage device, a ring tone generator, and a controller. The connector is used for physically connecting the cellular phone to a connection port of a computer. The storage device stores data. The ring tone generator generates a ring tone when an incoming call is received. The controller determines whether the cellular phone is operating in a storage mode or a phone mode. When operating in storage mode, the cellular phone receives a ring tone file from the computer via the connector, and stores the received ring tone file in the storage device. When operating in phone mode, the cellular phone receives an incoming call, and the ring tone generator generates a ring tone according to the received ring tone file.

A method of manipulating a cellular phone is also provided. The cellular phone is capable of operating in a storage mode and a phone mode, wherein the cellular phone comprises a connector and a nonvolatile storage device. A connection interrupt is first detected. The storage mode is then activated. Data is received from an external device via the connector. The received data is stored in the nonvolatile storage device.

A method of processing data is also provided. A computer is first provided, wherein the computer comprises a computer file system and a connection port. A cellular phone is provided. The cellular phone is capable of operating in a storage mode or a phone mode, comprising a connector through which the cellular phone is capable of being physically connected to the connection port of the computer. When the cellular phone is physically connected to the connection port of the computer, the storage mode of the cellular phone is activated. Data is received from the computer via the physical connection. The received data is stored in the storage device under the direction of the computer file system.

A method of processing data is also provided. A computer is provided, wherein the computer comprises a computer file system and a connection port. A cellular phone is provided. The cellular phone is capable of operating in a storage mode or a phone mode, comprising a connector and a phone file system. The connector is used for physically connecting the cellular phone to the connection port of the computer. The phone file system manages data under the phone mode. When the cellular phone is physically connected to the connection port of the computer, the storage mode of the cellular phone is activated. In the storage mode, a ring tone file is received from the computer via the physical connection based on a connection standard. The received ring tone file is then stored under the directions of the computer file system. The phone mode of the cellular phone is activated. When an incoming call is received, a ring tone is generated according to the received ring tone file.

### DESCRIPTION OF THE DRAWINGS

The invention can be more fully understood by reading the subsequent detailed description and examples with references made to the accompanying drawings, wherein:

FIG. 1 is a schematic view of a conventional computer utilizing a cellular phone as an external storage device;

FIG. 2 is a schematic view of an embodiment of a cellular phone connecting with a computer system of the invention;

FIG. 3 shows a block diagram of an embodiment of a cellular phone of the invention;

FIG. 4 is a schematic diagram of a storage stack of an embodiment of a cellular phone and a computer system;

FIG. 5A illustrates operation of an embodiment of a cellular phone in a storage mode;

FIG. 5B illustrates operation of an embodiment of a cellular phone in a phone mode; and

FIGS. 6A and 6B illustrate two embodiments of cellular phone switching to a storage mode.

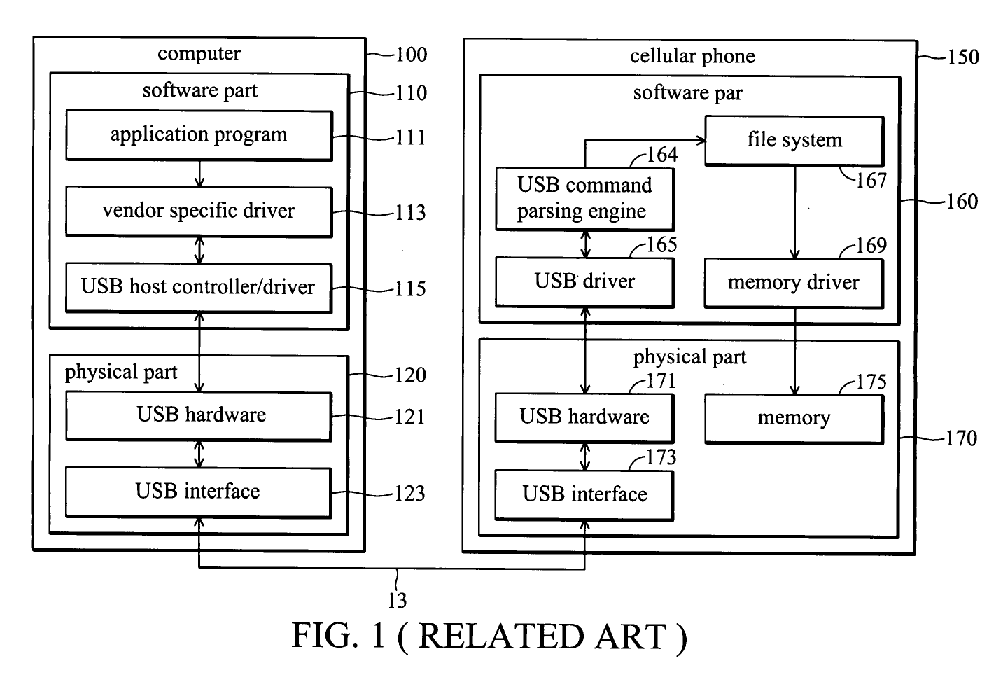

### DETAILED DESCRIPTION

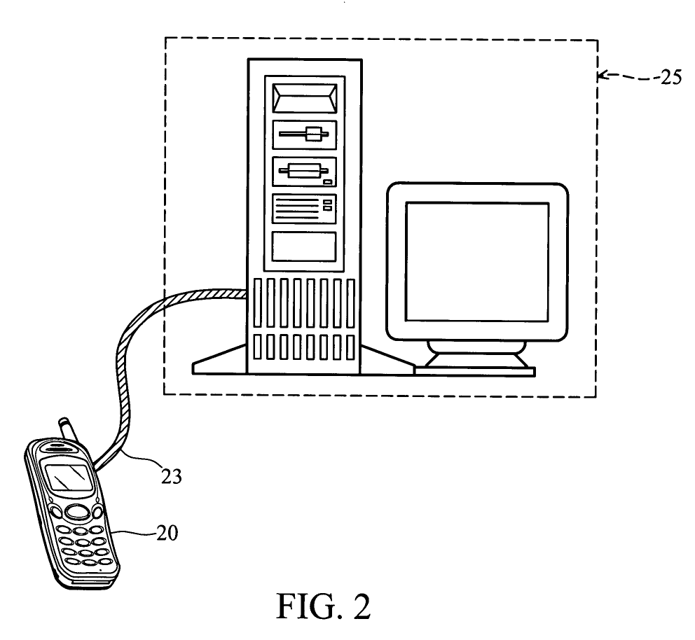

The invention will now be described with reference to FIGS. 2 through 6, which generally relate to cellular phone operations. While some embodiments of the invention are applicable to storage and utilization of a ring tone file, it is understood that other data files employed by a cellular phone may be implemented, such as an image file and a video file.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures.

FIG. 2 is a schematic view of an embodiment of a cellular phone connecting with a computer system of the invention. A cellular phone 20 connects with a computer system 25 via a Universal Serial Bus (USB) cable 23. Data originally stored in and/or generated by the computer system 25 may be transferred to the cellular phone 20 via the USB cable 23. The transferred data can be stored in an internal memory of the cellular phone 20 and be utilized thereby. For example, the data can comprise image data, multimedia data, MP3 data, ring tone data, or other data that can be utilized during operation of the cellular phone.

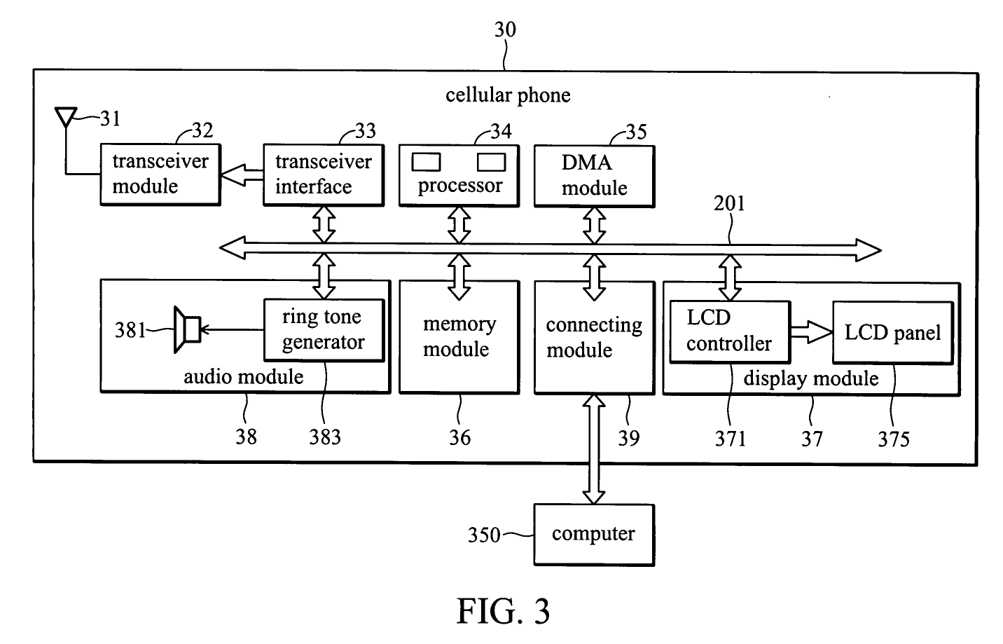

FIG. 3 shows a block diagram of an embodiment of a cellular phone of the invention. A cellular phone 30, as shown in FIG. 3, chiefly includes an antenna 31, a transceiver module 32, a transceiver interface 33, a processor 34, a DMA module 35, a memory module 36, a display module 37, an audio module 38, and a connecting module 39. The audio module 38 comprises a speaker 381 and a ring tone generator 383. The cellular phone 30 connects to a computer 350 via the connecting module 39.

The display module 37, comprising a LCD controller 371 and a LCD panel 375, visually presents information to a user. An operating module (not shown), comprising a keyboard and/or a touch panel, can be used for inputting a command to operate the cellular phone. The antenna 31 receives and transmits radio signals. The transceiver module 32, connecting to the antenna 31 and the transceiver interface 33, receives and transmits radio signals via the antenna 31. The memory module 36 stores operating programs, ring tone files, still image files, video files, phonebooks, and other utilizable data. The memory module 36 comprises a non-volatile memory, such as a flash memory. When an incoming call is received, the ring tone generator 383 generates a ring tone according to the ring tone file stored in the memory module 36, and the speaker 381 emits the ring tone. Also, the display module 37 may display the image/video file when the incoming call is received. The speaker 381 emits audio signals, alarm signals, and other audible signals. A microphone (not shown) is used for receiving voice of the user.

The connecting module 39 connects the cellular phone 30 to another device, such as a computer system 350, via a USB (Universal Serial Bus) and/or UART (Universal Asynchronous Receiver/Transmitter) interface.

The connecting module 39 connects the cellular phone 30 to another device, such as a computer system 350. The connecting module 39 can be designed to comply different connection standards for meeting requirements. Therefore, the connecting module 39 may be a USB (Universal Serial Bus) connecting module or a UART (Universal Asynchronous Receiver/Transmitter) connecting module.

The UART or universal asynchronous receiver-transmitter is a piece of computer hardware of an electronic device, such as a computer, that takes bytes of data and transmits the data bits in a sequential way. The UART is usually an integrated circuit used for serial communications over a computer or peripheral device serial port.

The connecting module 39 may also be an IEEE 1394 connecting module. The IEEE 1394 (also known as i.Link or FireWire) is a serial bus interface standard offering high-speed communications and isochronous real-time data services.

The connecting module 39 may also be a Bluetooth connecting module. The Bluetooth is an industrial specification for wireless personal area networks (PANs). Bluetooth provides a way to connect and exchange information between devices like personal digital assistants (PDAs), mobile phones, laptops, PCs, printers and digital cameras via a secure, low-cost, globally available short range radio frequency.

The connecting module 39 may also be an IrDA connecting module. IrDA refers to Infrared Data Association, a standard for communication between devices (such as computers, PDAs and mobile phones) over short distances using infrared signals.

The connecting module 39 may also be an NFC connecting module. Near Field Communication Technology or NFC jointly developed by Sony and Phillips was approved as an ISO/IEC standard on Dec. 8, 2003. It was approved as an ECMA standard earlier on. Near Field Communication Technology holds the promise of bringing true mobility to consumer electronics in an intuitive and psychologically comfortable way since the devices can hand-shake only when brought literally into touching distance.

The connecting module 39 may also be a WIFI connecting module. Wi-Fi (sometimes written Wi-fi, WiFi, Wifi, wifi) is a trademark for set of product compatibility standards for wireless local area networks (WLANs). Wi-Fi, short for “Wireless Fidelity”, was intended to allow mobile devices, such as laptop computers and personal digital assistants (PDAs) to connect to local area networks, but is now often used for Internet access and wireless VoIP phones. Wi-Fi is based on the IEEE 802.11 specifications.

The connecting module 39 may also be a ZigBee connecting module. ZigBee is a published specification set of high level communication protocols designed to use small, low power digital radios based on the IEEE 802.15.4 standard for wireless personal area networks (WPANs). The relationship between IEEE 802.15.4 and ZigBee is analogous to that existing between IEEE 802.11 and the Wi-Fi Alliance. The ZigBee 1.0 specifications were ratified on Dec. 14, 2004 and are available to members of the ZigBee Alliance.

A signal modulating/demodulating module (not shown) modulates signals to be sent and demodulates received signals. The processor 34 controls operations of the cellular phone according to programs stored in the memory module 36, and may be a central processing unit (CPU).

The cellular phone 30 operates in a storage mode and/or a phone mode. When the cellular phone 30 operates in the storage mode, it can receive data from the computer 350, and be used as an external storage device of the computer 350. When the cellular phone 30 operates in the phone mode, it provides communication functionalities via a telephone network, other functions related to making and receiving phone calls, or other default functionality provided by a phone manufacturer. The data received during the storage mode can be utilized while operating in the phone mode.

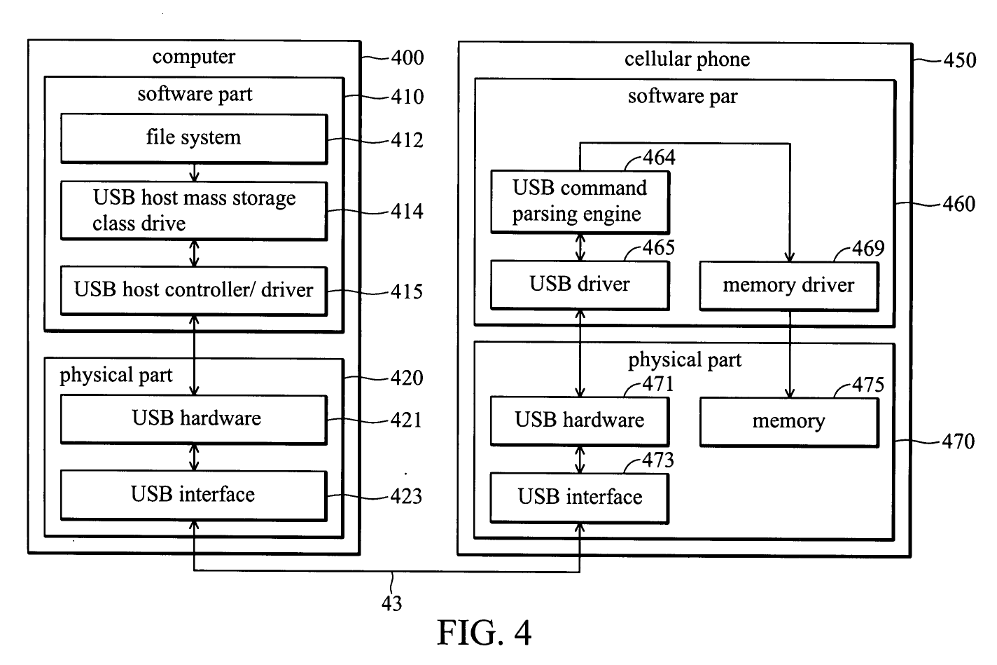

FIG. 4 is a schematic diagram of a storage stack of an embodiment of a cellular phone and a computer system.

A cellular phone 450 is connected to a computer 400 via a USB cable 43. As mentioned, the cellular phone 450 can be connected to the computer 400 via different connection standards. Here, the USB connection standard is an example for describing the present invention. Both computer 400 and cellular phone 450 comprise hardware and software components, wherein the computer 400 comprises a hardware component 420 and a software component 410, and the cellular phone 450 comprises a hardware component 470 and a software component 460. The software component 410 comprises a file system 412, a USB host mass storage class driver 414, and a USB host controller/driver 415. Typically, the file system 412 and USB host mass storage class driver 414 are provided in an operating system installed in the computer system 400, such as the Windows™ operating system. In order to communicate with an external device via the USB cable 43, the hardware component 420 comprises USB hardware 421 and a USB interface 423. In order to receive and transmit data via the USB cable 43, the hardware component 470 comprises USB device 471 and a USB interface 473, and the software component 460 comprises a USB driver 465 and a USB command parsing engine 464. The USB command parsing engine 464 parses a command submitted via the USB host mass storage class driver 414, and data stored in a memory 475 is retrieved and/or stored accordingly. Utilization of the data stored in the memory 475 is implemented through a memory driver 469. For example, the memory 475 equipped in the cellular phone 450 is a non-volatile memory, such as a flash memory, and the memory driver 469 is a Flash driver.

A file system and USB host mass storage class driver are provided in a general operating system. The described storing/retrieving of data stored in the phone memory can be realized in a computer equipped with a common file system and a USB driver conforming to the USB standard. Here, the file system is a mechanism for storing and organizing files and the data they contain to make it easy to find and access them. File systems may use a storage device and involve maintaining the physical location of the files, or they may be virtual and exist only as an access method for virtual data or for data over a network (e.g. NFS). More formally, a file system is a set of abstract data types that are implemented for the storage, hierarchical organization, manipulation, navigation, access, and retrieval of data.

The described storing/retrieving of data stored in the phone memory can be realized without installing particular software in a computer in advance.

Data stored in the memory 475 can be manipulated when the cellular phone 450 operates in a storage mode and a phone mode, respectively. For example, data input from the computer 400 in the storage mode can be utilized as a ring tone file used for ring tone generation when receiving an incoming call in the phone mode. The memory driver 469 and memory 475 operates in both the phone mode and storage mode.

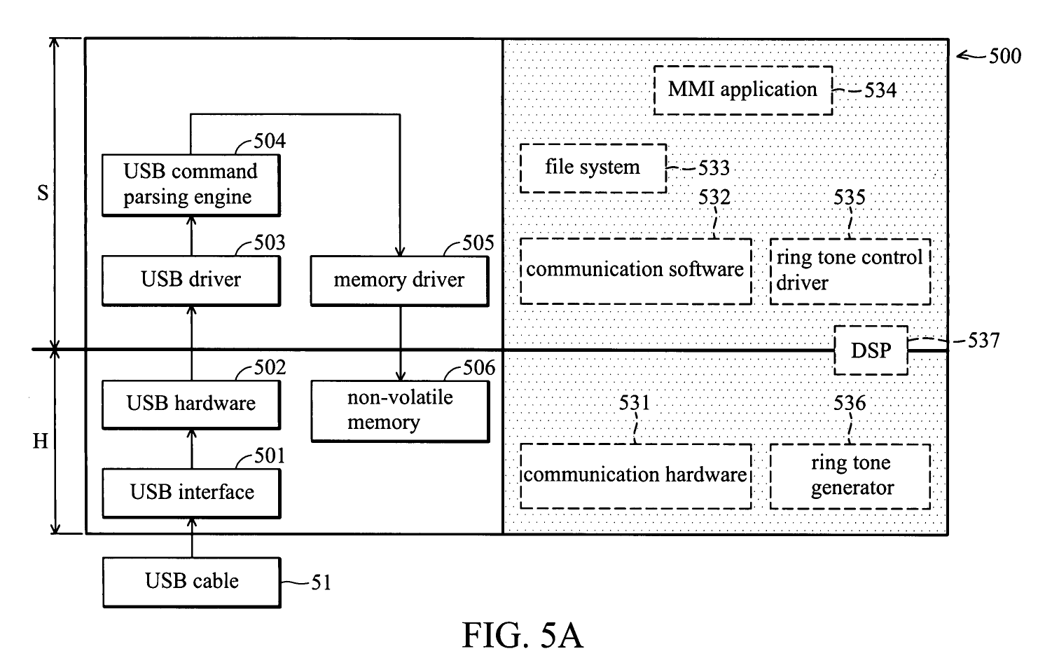

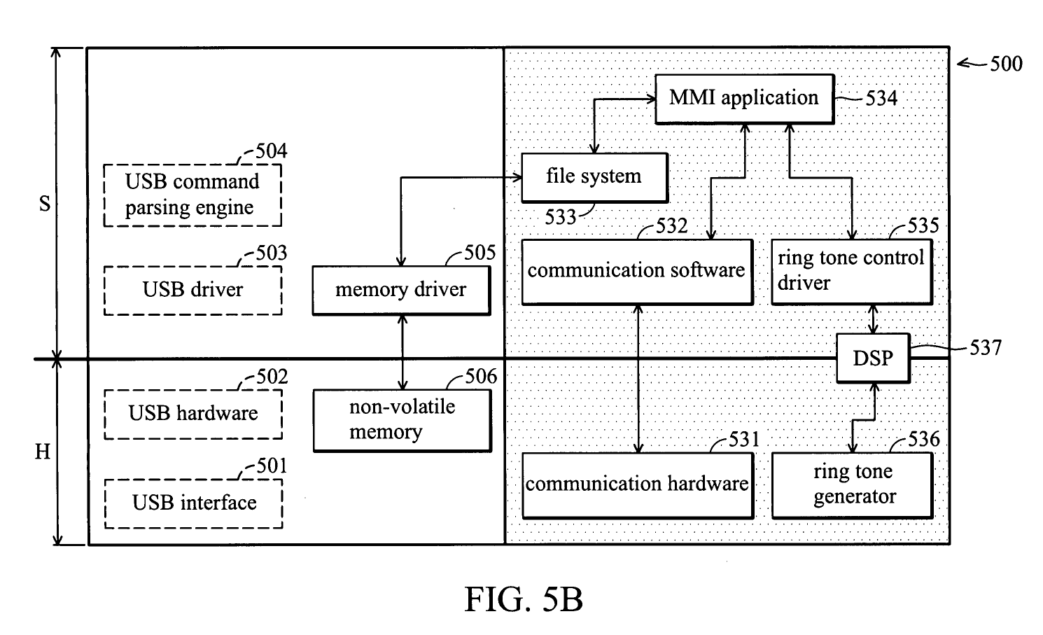

FIG. 5A illustrates operation of a cellular phone in a storage mode. A cellular phone 500 comprises a software component ‘S’ and a hardware part ‘H’. The software component ‘S’ and the hardware part ‘H’ comprise a plurality of operation units, wherein operation units utilized in a storage mode are represented as solid-line blocks, and operation units utilized in a phone mode are represented as dotted-line blocks.

When a USB cable 51 connects a computer and cellular phone 500, a USB interface 501 detects the connection and a USB interrupt will be generated. When the USB cable connection (i.e. the USB interrupt) is detected, the phone-mode related function blocks are disabled, which is represented as dotted-line blocks. In some embodiment, when the USB connection is detected, the cellular phone will be automatically or has to be manually powered off and then automatically/manually powered on so as to re-initiate the cellular phone in the storage mode. In some embodiments, when the USB connection is detected, the cellular phone will be automatically or has to be manually switched from the phone mode to the storage mode by disabling the communication functionalities of the cellular phone and enabling/activating the cellular phone to be the external storage device of the connected computer.

The cellular phone 500 in the storage mode communicates with the connected computer through the USB cable 51. Data (sound, images, MP3 . . . ) can be transmitted to the cellular phone 500 via the USB cable 51 and stored in a non-volatile memory 506. When a command specifying data manipulation is received, from the connected computer, by the USB interface 501 via the USB cable 51, the command is transmitted to a USB command parsing engine 504 via USB device 502 and a USB driver 503. The command is parsed in the USB command parsing engine 504 to determine whether data writing or retrieving is required. According to the parsed command, a memory driver 505 will input and/or retrieve data into and/or from the memory 506 accordingly. In the storage mode, data writing and/or retrieving is managed by a file system (not shown in FIG. 5A) provided by an operating system of a computer system (not shown in Fig. 5A) connected to the cellular phone 500 via the USB cable 51. The data manipulation is implemented in a cellular phone and a computer system illustrated in FIG. 4. As illustrated in FIG. 4, data manipulation is managed by the file system 412 of the computer system 400.

Without connection to the computer, the cellular phone 500 is operated in the phone mode. When the connection of the cellular phone and the computer is removed, similarly, in some embodiment, the cellular phone will be automatically or has to be manually powered off and then automatically/manually powered on so as to re-initiate the cellular phone in the phone mode. Also, in some embodiments, when the connection is removed, the cellular phone will be automatically or has to be manually switched from the storage mode to the phone mode by enabling/re-activating the communication functionalities of the cellular phone. Using FIG. 5B as an example, data stored in the memory 506 can be utilized via the file system 533 when the cellular phone 500 operates in the phone mode. Here, the functional units used for phone mode operation are represented as solid-line blocks, while the functional units not used for the phone mode are represented as dotted-line blocks. Here, the memory driver 505 and memory 506 can be used for both the phone mode and the storage mode. For example, when an incoming call is received by communication hardware 531, and signals specified by the incoming call are transmitted to a MMI application 534 via communication software 532. The MMI application 534 directs a file system 533 to retrieve a ring tone file from the memory 506 via the memory driver 505. The retrieved ring tone file is then utilized by the ring tone control driver 535. The ring tone control driver 535 controls a ring tone generator 536 via a DSP 537. The ring tone generator 536 generates a ring tone according to the retrieved ring tone file. The data stored in the memory 506 can be sound data, image/video data, MP3 data, and/or other type of data. The data stored in the memory 506 when the cellular phone is in the storage mode can be utilized when the cellular phone executes various communication-related and/or unrelated functions in the phone mode. Beside the ring tone generation, in response to the receiving call, the cellular phone may display a still image or an animation (i.e. video). Similarly, the MMI application 534 directs the file system 533 to retrieve a image/video file from the memory 506 via the memory driver 505. The retrieved image/video file is then utilized by the image/video control driver (not shown), and the driver controls an image/video related hardware to display an image/video on the display according to the retrieved image/video file.

Generally, the phone mode is a default operating mode of a cellular phone. When operating in a phone mode, the cellular phone provides various functionalities. For example, cellular phones can be used to place telephone calls, take photographs, access the Internet, send and receive email, check stock quotes and sports scores, as well as operate as a personal digital assistant (or PDA) and/or MP3 player. Programs directing to the described functionalities and data utilized thereby can be stored in an internal memory of the cellular phone. Additionally, the data received and stored in the internal memory when the cellular phone is in the storage mode can be the aforementioned programs and/or data. Here, data specifying a ring tone file is used as an example, wherein a ring tone generated when receiving an incoming call is defined by the ring tone file. Here, the ring tone file may be downloaded from a web site via the Internet, and stored in a computer system. The ring tone file is transmitted to the cellular phone and stored in the internal memory during the described storage mode.

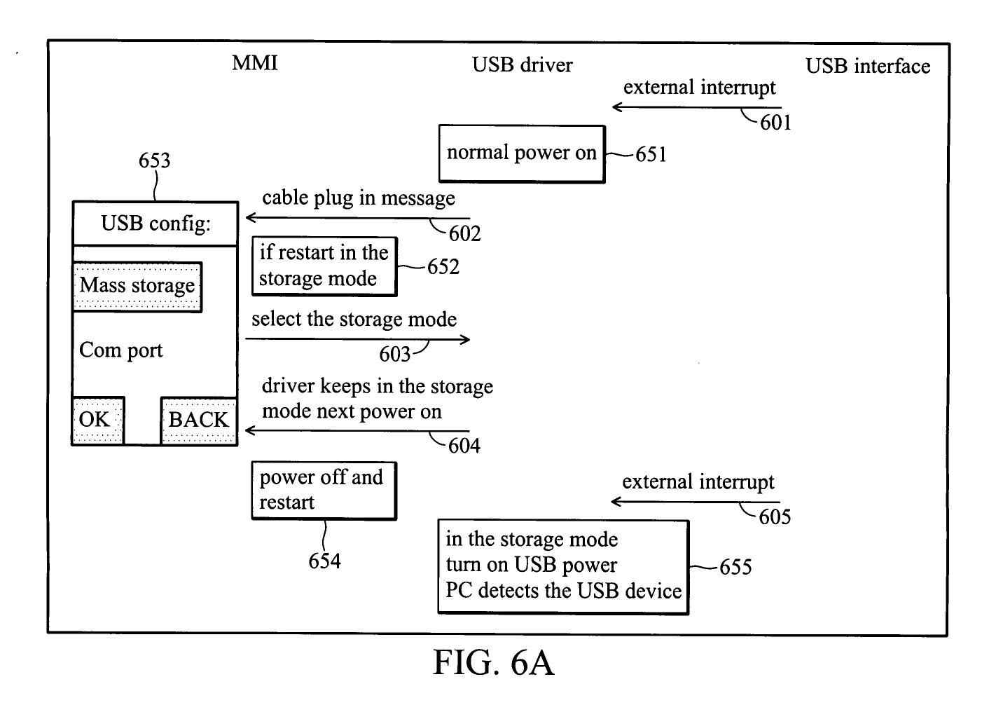

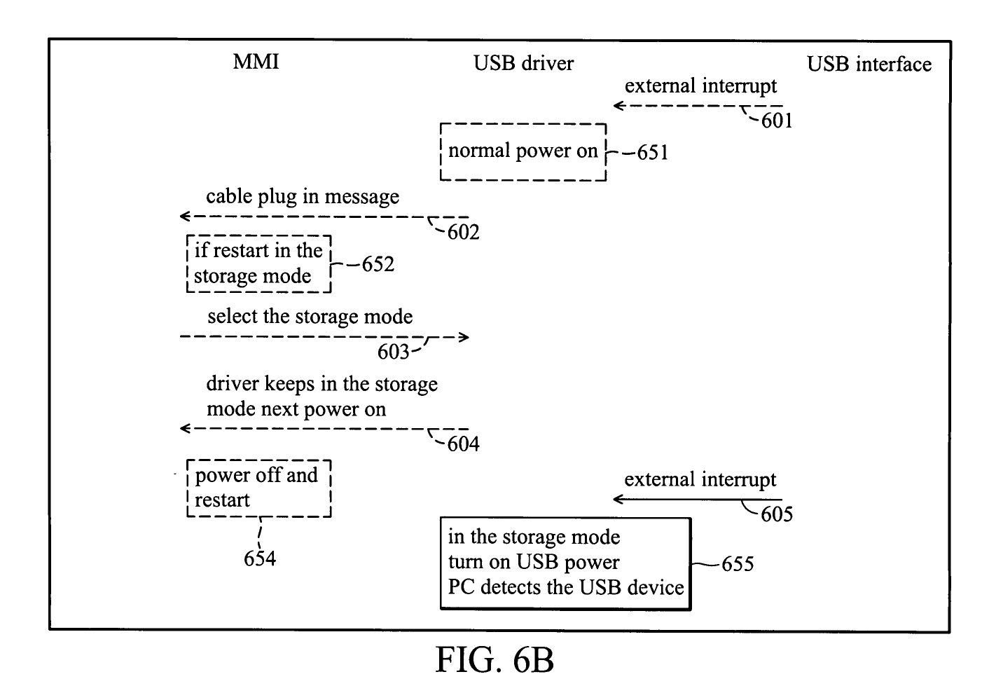

FIGS. 6A and 6B illustrate embodiments of operation of a cellular phone switched to a storage mode according to the invention, wherein the cellular phone comprises a USB interface and USB device. FIG. 6A illustrates operations implemented in a powered-on cellular phone, and FIG. 6B illustrates operations implemented in a powered-off cellular phone.

Using FIG. 6A as an example, the described phone mode is typically set as a default operating mode of a powered-on cellular phone. When the cellular phone is connected to a computer system via a USB cable, an external interrupt (USB interrupt) 601 is generated. Under a normal powered-on situation 651, a USB driver transmits a cable plug-in message 602. It is then determined whether the cellular phone is reinitiated in a storage mode (block 652). USB configuration of the cellular phone is selected by a user using a display illustrated in block 653 and an input device. When a ‘mass storage’ configuration is selected (603), the USB driver is set to operate in the storage mode when the cellular phone is reinitiated (604). The cellular phone is powered off and restarted in block 654. When the cellular phone is restarted with the USB cable connected thereto, an external interrupt (i.e. a USB interrupt) 605 is detected. The cellular phone operates in the storage mode, and is detected by a computer system connected via the USB cable (block 655). The data manipulation implemented in the cellular phone and a computer system under the storage mode is illustrated in FIGS. 4 and 5A. As illustrated in FIG. 4, data manipulation is managed by the file system 412 of the computer system 400.

Using FIG. 6B as an example, the cellular phone is powered off when connected to a computer system via a USB cable. When the cellular phone is connected to a computer system via a USB cable, an external interrupt (i.e. a USB interrupt) 605 is detected. The cellular phone is initiated and operates in the storage mode, and is detected by a computer system connected via the USB cable (block 655). The data manipulation implemented in the cellular phone and a computer system under the storage mode is illustrated in FIGS. 4 and 5A. As illustrated in FIG. 4, data manipulation is managed by the file system 412 of the computer system 400.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cellular phone, comprising:
a connector through which the cellular phone is capable of being connected to a connection unit of a computer;
a nonvolatile storage device storing data; and
a controller determining whether the cellular phone operates in a storage mode or a phone mode, wherein:
the cellular phone operating in the storage mode receives data from the computer via the connector, and stores the received data in the storage device;
the cellular phone operating in the phone mode executes a default functionality of the cellular phone.

2. The cellular phone of claim l, wherein the nonvolatile storage device comprises a flash memory.

3. The cellular phone of claim 1, wherein the data for operating the default functionality is stored in the nonvolatile storage device.

4. The cellular phone of claim 1, further comprising a ring generator generating a ring tone when an incoming call is received under the phone mode, wherein the ring tone is generated according to the data stored in the nonvolatile storage device.

5. The cellular phone of claim 1, wherein the controller further switches off the cellular phone, and reinitiates the cellular phone in the storage mode when the connector is connected to the connection port of the computer.

6. The cellular phone of claim 1, wherein the controller further disables functionalities of the phone mode, and activates the storage mode when the connector is connected to the connection port of the computer.

7. The cellular phone of claim 1, wherein the data, received from the computer via the connector, specifies audio signals used for ring tone generation when receiving an incoming call.

8. The cellular phone of claim 1, wherein the data, received from the computer via the connector, specifies an audio file played in the phone mode.

9. The cellular phone of claim 1, wherein the USB device receives data from the computer system, specifying an image/video file played in the phone mode.

10. The cellular phone of claim 1, wherein data input to and retrieved from the nonvolatile storage device under the storage mode is manipulated by a file system of the computer system.

11. The cellular phone of claim 1, wherein data retrieved from the nonvolatile storage device for further utilization under the phone mode is manipulated by a file system of the cellular phone.

12. The cellular phone of claim 1, wherein the connector/connection unit comprises one of the followings: a USB connector/connection unit, a UART connector/connection unit, an IEEE 1394 connector/connection unit, a Bluetooth connector/connection unit, an IrDA connector/connection unit, a NFC connector/connection unit, a WIFI connector/connection unit, and a ZigBee connector/connection unit.

13. A cellular phone, comprising:
a phone file system;
a connector through which the cellular phone is capable of being connected to a computer having a computer file system;
a nonvolatile storage device storing data; and
a controller determining whether the cellular phone operates in a storage mode or a phone mode, wherein:
when the cellular phone is connected to the computer via the connector, the cellular phone operates in the storage mode, receiving data from the computer via the connector, and stores the received data in the nonvolatile storage device under the directions of the computer file system;
when the cellular phone is disconnected with the computer, the cellular phone operates in the phone mode, executing a default functionality of the cellular phone, and accesses the data stored in the nonvolatile storage device under the directions of the phone file system.

14. The cellular phone of claim 13, wherein the nonvolatile storage device comprises a flash memory.

15. The cellular phone of claim 13, further comprising a ring generator generating a ring tone when an incoming call is received under the phone mode, wherein the ring tone is generated according to the data stored in the nonvolatile storage device.

16. The cellular phone of claim 13, wherein the controller further switches off the cellular phone, and reinitiates the cellular phone in the storage mode when the connector is connected to the connection port of the computer.

17. The cellular phone of claim 13, wherein the controller further disables functionalities of the phone mode, and activates the storage mode when the connector is connected to the connection port of the computer.

18. The cellular phone of claim 13, wherein the data, received from the computer via the connector, specifies audible signals used for ring tone generation when receiving an incoming call, and the cellular phone further comprises a speaker emitting the audible signals under the phone mode.

19. The cellular phone of claim 13, wherein the data, received from the computer via the connector, specifies an audio file played under the phone mode, and the cellular phone further comprises a speaker emitting the audio file under the phone mode.

20. The cellular phone of claim 13, wherein the USB device receives data from the computer system, specifying an image/video file played under the phone mode, and the cellular phone further comprises a display device displaying the image/video data under the phone mode.

21. The cellular phone of claim 13, wherein the connector comprises one of the followings: a USB connector, a UART connector, an IEEE 1394 connector, a Bluetooth connector, an IrDA connector, a NFC connector, a WIFI, and a ZigBee connector.
